(19) United States
(12) Patent Application Publication
(10) Pub. No.: US 2006/0095824 A1
(43) Pub. Date: May 4, 2006

(54) Determining circuit behavior

(76) Inventor: Michael S. McGrath, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/979,010

(22) Filed: Nov. 1, 2004

(51) Int. Cl. G06F 11/00; G06F 17/50; G06G 7/62

(52) U.S. Cl. 714/741; 703/13; 716/4

(57) ABSTRACT

Systems, methodologies, media, and other embodiments associated with automatically determining circuit behavior are described. One exemplary system embodiment includes a data acquisition logic that is configured to access a netlist that describes a computer circuit. The exemplary system may also include a logical behavior logic that is configured to facilitate determining a predicted logical behavior for the computer circuit based, at least in part, on the netlist. The exemplary system may also include a test vector logic configured to generate a set of test vectors. The test vectors may facilitate analyzing the computer circuit. The test vectors may be based, at least in part, on the predicted logical behavior for the computer circuit.

### BACKGROUND

Computer circuits (e.g., sequential and/or combinational logic circuits) continue to become larger, denser, more complicated, and more difficult to analyze. Some circuit analysis tools consider cell topologies, where a cell may contain a collection of transistors that are connected into an electrical circuit. However, conventional topology-based tools may be confused by complex circuits. For example, circuits with tri-state ports may confound conventional analysis tools.

Cell inputs and outputs may be referred to as pins, and interconnections between cells may be referred to as nets. Some conventional circuit analysis tools may gather information about circuit inputs. Various data structures, maps, diagrams, and so on, may describe these circuits and their inputs. By way of illustration, a netlist may include information concerning sets of connections between cell pins. By way of further illustration, a portion of a circuit may be represented as a Boolean network, like a directed acyclic graph, where a node may represent a single-output logic function and an edge may represent a dependency between an input and an output on corresponding logic functions. But these conventional circuit analysis tools may require detailed information concerning inputs like whether an input is a clock signal, whether an input is a clock enable signal, whether an input is a synchronous reset signal, whether an input is an asynchronous reset signal, and so on. This information is not typically available in a netlist or a directed acyclic graph.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. The drawings are not necessarily to any scale.

FIG. 1 illustrates an example circuit whose circuit behavior may be determined.

FIG. 2 illustrates an example method associated with determining circuit behavior.

FIG. 3 illustrates an example system for determining circuit behavior.

FIG. 4 illustrates an example method associated with generating test vectors based on an automatic determination of circuit behavior.

FIG. 5 illustrates an example computing device with which example systems and methods may operate.

FIG. 6 illustrates an example application programming interface (API).

### DETAILED DESCRIPTION

This application describes an example computer program that uses a circuit netlist and a switch level circuit simulator to infer the logical behavior of a circuit. Knowledge about the logical behavior of the circuit can then be used to generate a set of test vectors for feature testing the circuit.

Test vectors (e.g., combinations of input values and output values) may be used, for example, to validate abstract circuit models (e.g., hardware description language (HDL) models) and/or to validate physical, manufactured versions of a computer circuit. Additionally, test vectors may facilitate verifying the quality of physical and/or abstract versions of a circuit. Thus, efficiently producing useful sets of test vectors may facilitate computer circuit analysis and/or validation.

If a computer circuit can be correctly simulated at the switch level, then computer circuit behavior may be determined by example systems and methods described herein. Computer circuit behavior knowledge may then facilitate producing test vectors that may, for example, facilitate feature testing the computer circuit.

Generating test vectors may include learning about computer circuit behavior, and then producing vectors based on the knowledge gained during the learning. Gaining the knowledge may include accessing a netlist that describes a computer circuit. Gaining the knowledge may also include accessing a switch level circuit simulator that is configured to determine a predicted logical behavior for the computer circuit from the netlist. In one example, an integrated circuit(s) may be configured to perform processing like that performed by a software based switch level circuit simulator. An example method may programmatically determine the predicted logical behavior for the computer circuit. Programmatically determining the predicted logical behavior may include, for example, creating and/or populating a state table that stores information about states the computer circuit can achieve and creating and/or populating a state transition table that stores information concerning transitions between those states. The state table may store, for example, inputs provided to the circuit and outputs produced by the computer circuit in response to those inputs. The state transition table may store, for example, inputs provided to the circuit while in a certain state, outputs produced by the computer circuit in response to those inputs, and states produced from those inputs. From the programmatically determined predicted logical behavior, example systems and methods may then generate a set of test vectors configured to facilitate analyzing a physical and/or logical implementation of a circuit.

CMOS (complementary metal oxide semiconductor) semiconductors include NMOS (negative channel metal oxide semiconductor) negative polarity circuits and PMOS (positive channel metal oxide semiconductor) positive polarity circuits. Computer circuit behavior knowledge gathered using example systems and methods described herein may be employed in applications including, but not limited to, automatically transforming a circuit design from one circuit family (e.g., static CMOS logic) to another family (e.g., pseudo NMOS logic, dynamic precharge logic).

The following includes definitions of selected terms used herein. The definitions include examples of various embodiments and/or forms of components that fall within the scope of a term and that may be used for implementation. Of course, the examples are not intended to be limiting and other embodiments may be implemented. Both singular and plural forms of these terms may fall within the meanings.

“Computer-readable medium”, as used herein, refers to a medium that participates in directly or indirectly providing signals, instructions and/or data to one or more processors for execution. Such a medium may take forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of electromagnetic radiation, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or card, a carrier wave/pulse, or any other medium from which a computer, a processor or other electronic device can read. Signals used to propagate instructions or other software over a network, like the Internet, or other transmission medium may also be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electromagnetic signals, optical, radio, AC or DC, analog or digital signals, one or more computer or processor instructions, messages, a bit or bit stream, or other means that can be received, transmitted, and/or detected.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may depend, for example, on requirements of a desired application, the environment on which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the present system and method using the teachings presented here include programming languages and tools such as Java, Pascal, C#, C++, C, CGI, PerI, SQL, APIs, SDKs, assembly, firmware, microcode, and/or other languages and tools. The components embodied as software include computer readable/executable instructions that cause one or more computers, processors and/or other electronic device to behave in a prescribed manner. Any software, whether an entire system or a component of a system, may be embodied as an article of manufacture and maintained as part of a computer-readable medium as defined previously. Another form of the software may include signals that transmit program code of the software to a recipient over a network or other communication medium. It will be appreciated that components described herein may be implemented as separate components or may be combined together.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like inferring, processing, computing, calculating, determining, displaying, or the like, refer to actions and processes of a computer system, logic, processor, or similar electronic device that manipulates and transforms data represented as physical (electronic) quantities.

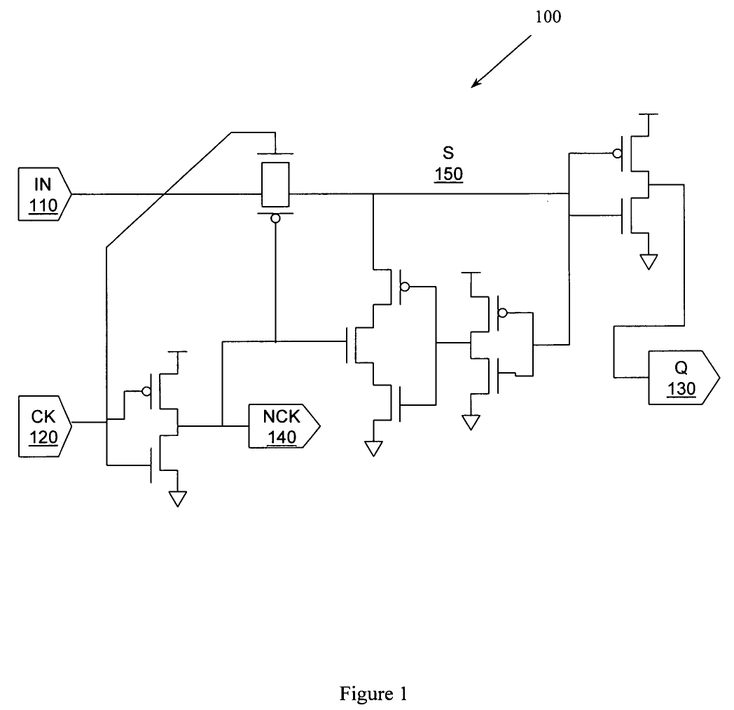

FIG. 1 illustrates a circuit 100. Circuit 100 includes two inputs, IN 110 and CK 120 (where CK may be, for example, a clock signal). Circuit 100 also includes a state node S 150, and two outputs, Q 130 and NCK 140. The value present at the two outputs depends on the values present at the two inputs and the value of the state node. It is to be appreciated that circuit 100 is provided to facilitate discussing and illustrating certain elements of the example systems and methods described herein. Thus, it will be further appreciated that computer circuits including, but not limited to, combinational circuits, sequential circuits, circuits that include tri-state ports, and so on, may be processed by example systems and methods described herein.

Example methods described herein may facilitate inferring the logical behavior of a circuit like circuit 100. Inferring the logical behavior of circuit 100 may include identifying potential state nodes in circuit 100, finding stable states in circuit 100, finding state transitions in circuit 100, and reducing the states associated with circuit 100.

The logical behavior of a circuit may be represented by a state table(s) and a state-transition table(s). A state table facilitates expressing values for circuit outputs as functions of circuit input values and circuit state node values. Thus, Table 1 is an example state table associated with circuit 100. Table 1 expresses the output values of circuit 100 as functions of the values input to circuit 100 and the values of the state node 150 in circuit 100. Knowledge about the logical behavior of circuit 100 can be gained by examining Table 1. For example, Table 1 shows that Output Q 130=NOT(S 150) and Output NCK 140=NOT(CK 120).

TABLE 1
State Table For Circuit 100

| Input Clock | | | | |
|---|---|---|---|---|
| (CK) | Input IN | State node S | Output Q | Output NCK |
| 0 | 0 | 0 | 1 | 1 |
| 0 | 0 | 1 | 0 | 1 |
| 0 | 0 | X | X | 1 |
| 0 | 1 | 0 | 1 | 1 |
| 0 | 1 | 1 | 0 | 1 |
| 0 | 1 | X | X | 1 |
| 1 | 0 | 0 | 1 | 0 |
| 1 | 1 | 1 | 0 | 0 |

Table 1 also includes information about the state node S 150 in circuit 100. In one example, rather than list values associated with a state node, a state table may include other identifiers (e.g., letters, codes) associated with possible values for a state node. By way of illustration “A” may be associated with the state (S=0), “B” may be associated with the state (S=1) and “C” may be associated with the state (S=X), where X indicates a “logical undefined” state.

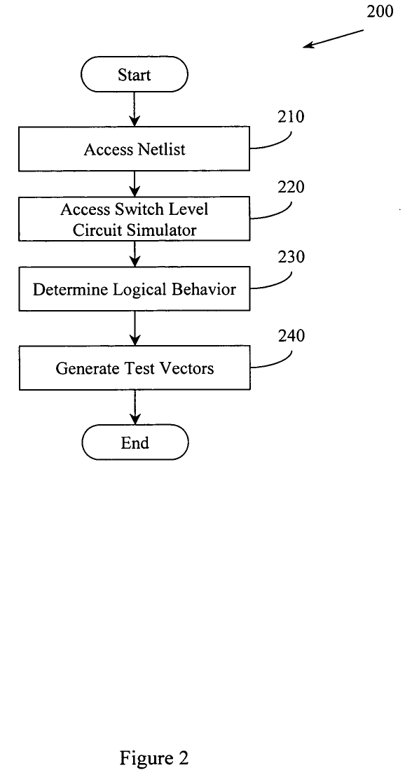

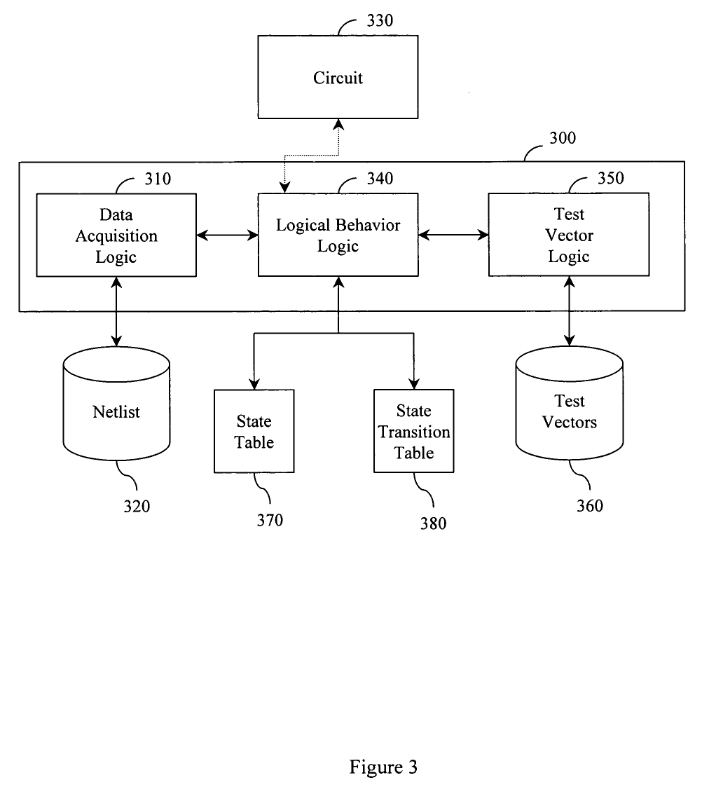

In some cases, a state table may not include entries for every possible combination of inputs, states, and outputs. For example, entries where CK 120 or IN 110 have undefined values, (e.g., X) may be omitted when such entries can be inferred or determined from other entries in the table. Similarly, for circuits that may include multiple state nodes, an identifier like a letter may be assigned to a combination of state node values. Thus, in one example, method 200 (FIG. 2) and/or system 300 (FIG. 3) may access a state table that uses these type of identifiers.

State transition tables can be constructed from information stored in a state table and analysis of a circuit in operation. Thus, Table 2 illustrates an example state transition table associated with circuit 100.

TABLE 2
State Transition Table For Circuit 100.

| | | Next State if CK | Next State if IN |
|---|---|---|---|
| Current | Current inputs | Changes to | Changes to |
| State | (CK, IN) | Opposite Value | Opposite Value |
| A (S = 0) | 0, 0 | A | A |
| A (S = 0) | 0, 1 | B | A |
| A (S = 0) | 1, 0 | A | B |
| B (S = 1) | 0, 0 | A | B |
| B (S = 1) | 0, 1 | B | B |
| B (S = 1) | 1, 1 | B | A |
| C (S = X) | 0, 0 | A | C |
| C (S = X) | 0, 1 | B | C |

A state transition table may, for example, specify a state a circuit will switch to when an input changes given the current state, current input values, and an input transition. As described above, letters may be employed to represent different circuit states. By way of illustration, “A” represents (S=0), “B” represents (S=1), and “C” represents (S=X). Like a state table, a state transition table may not include entries for every possible combination of inputs, states, and outputs. For example, entries where CK 120 or IN 110 have undefined values, (e.g., X) may be omitted when such entries can be inferred or determined from other entries in the table. By way of illustration, Table 2 shows that circuit 100 changes state when CK 120=1, or, by inference, when CK 120=X.

Data stored in a state table and a state transition table may facilitate describing the logical behavior of a circuit. For example, Table 1 and Table 2 may describe the logical behavior of circuit 100. Therefore, tables like Table 1 and Table 2 may facilitate generating test vectors. Thus, example systems and methods described herein may automatically generate and/or simplify state and state transition tables to facilitate producing test vectors. While the example systems may describe generating a state table and/or state transition tables, it is to be appreciated that in some examples no static representation of a complete state table may be provided as an output. Rather, states and transitions may be identified and used in producing test vectors. Thus, in some examples, generating a table may include using table entries without producing a final, static, output like a data file.

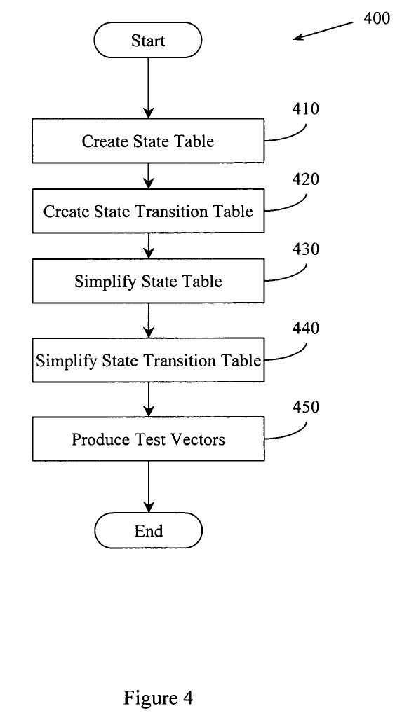

Example methods may be better appreciated with reference to the flow diagrams of FIGS. 2 and 4. While for purposes of simplicity of explanation, the illustrated methodologies are shown and described as a series of blocks, it is to be appreciated that the methodologies are not limited by the order of the blocks, as some blocks can occur in different orders and/or occur concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that methods may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques. It will be appreciated that in one example, methodologies, logic, and other means described herein and their equivalents can be implemented as processor executable instructions and/or operations provided by or stored on a computer-readable medium.

FIG. 2 illustrates an example method 200 associated with determining circuit behavior. Method 200 may include, at 210, accessing a netlist that is configured to describe a computer circuit. As described above, a netlist may include information concerning sets of connections between circuit elements (e.g., between cell pins).

Method 200 may also include, at 220, accessing a switch level circuit simulator that is configured to facilitate determining a predicted logical behavior for the computer circuit based, at least in part on data stored in the netlist.

Method 200 may also include, at 230, programmatically determining the predicted logical behavior for the computer circuit. In one example, the switch level circuit simulator may perform programmatic actions associated with determining the predicted logical behavior. Programmatically determining 230 the predicted logical behavior for the computer circuit may include, for example, identifying state nodes associated with the computer circuit. Identifying a state node may include, for example, identifying an electrical feedback loop in the computer circuit. An example electrical feedback loop may follow a path that goes through a transistor gate connected to a node being considered as a state node and returns to the node through one or more transistors using only gate to source, gate to drain, drain to source, and source to drain paths. Additionally, and/or alternatively, identifying a state node may include examining a node that is connected to a gate and tracing a path from the gate. Tracing a path from the gate may involve, for example, determining whether a node is connected to a gate of at least one transistor in the computer circuit and determining whether the node has a transistor channel connection other than the source and drain connections of a single inverter in the computer circuit. Tracing a path from the gate may also include, for example, determining whether the node is part of a path that includes a transistor gate to which the node is connected. Some paths may identify a node as not being a state node. For example, if the path includes a source to gate path or a drain to gate path then the node may not be a state node. However, other paths may identify a node as being a state node. For example, if the path includes a gate to source path, a gate to drain path, a drain to source path, or a source to drain path, then the node may be a state node.

While path tracking is described above as one method for identifying a state node, a different approach, like determining whether a node is identified as a state node in the netlist may be employed. For example, a netlist data entry may include a field that indicates whether a node is a state node. After identifying a state node, method 200 may update a state table to record the identification of a state node. For example, method 200 may add, change, create, or otherwise manipulate a record in a state table to record the fact that a certain node in the computer circuit is a state node. While a state table is described, it is to be appreciated that other data structures like a list, an array, a tree, an object, and so on may be employed to store state node information.

Programmatically determining 230 the predicted logical behavior for the computer circuit may also include identifying stable states for state nodes. In one example, identifying a state node as having a stable state may include controlling the switch level circuit simulator to perform certain actions. The actions may include, for example, establishing an initial known input value for inputs associated with the computer circuit, establishing an initial known node value for state nodes associated with the computer circuit and then simulating the operation of the circuit. Identifying a stable state may also include determining whether a state node acquired a different node value than its initial known node value after the simulation, where the state nodes can take on values based on the inputs.

After identifying a stable state node, method 200 may update a state table to record the identification of a stable state node. For example, method 200 may add, change, create, or otherwise manipulate a record in a state table to record the fact that a certain node in the computer circuit is a stable state node. While a state table is described, it is to be appreciated that other data structures like a list, an array, a tree, an object, and so on may be employed to store state node information to record the identification of a stable state for a state node.

In different examples, method 200 may be configured to attempt to generate test vectors 240 that facilitate testing portions of a circuit, substantially all of a circuit, and/or all of a circuit. Thus, in one case, establishing the initial known input value for inputs associated with the computer circuit may include selectively establishing all possible combinations of logical ones and logical zeroes for the inputs. In another example, establishing the initial known input value for inputs associated with the computer circuit may include selectively establishing a set of combinations of logical ones and logical zeroes for inputs associated with the computer circuit.

Similarly, establishing the initial known node value for state nodes associated with the computer circuit may include selectively establishing different sets (e.g., some, substantially all, all) of possible combinations of logical ones, logical zeroes, and logical undefined values for the state nodes associated with the computer circuit.

Programmatically determining 230 the predicted logical behavior for the computer circuit may also include identifying state transitions between stable states. Identifying state transitions may include, for example, controlling the switch level circuit simulator to perform certain actions. The actions may include, for example, establishing an initial known node value for a state node associated with the computer circuit where the initial known node value is retrieved from a state table. The actions may also include, for example, establishing an initial known input value for a set of inputs associated with the computer circuit, where the initial known input value is also retrieved from the state table. As described above, while a state table is described, it is to be appreciated that other data structures may be employed.

The actions may also include, for example, simulating the operation of the circuit and, after the simulation has run, to record a first node value for the state node. With the first node value recorded, the actions may then include establishing a second known input value for the set of inputs associated with the computer circuit and then resimulating the operation of the circuit. After the resimulation, a comparison can be made to determine whether the state node took on a different value than the value recorded after the first simulation. If a state transition is detected, then method 200 may also include, selectively updating a state transition table to record a state transition.

Programmatically determining 230 the predicted logical behavior for the computer circuit may also include selectively reducing the number of states associated with the computer circuit. Selectively reducing the number of states associated with the computer circuit may include, for example, selectively combining stable states into a single stable state.

Selectively combining stable states into a single stable state may include, for example, comparing a first stable state to a second stable state to determine whether the first stable state and the second stable state are compatible. This may involve, for example, determining whether an input value combination associated with the first stable state is also associated with the second stable state. Additionally, and/or alternatively, this may involve, determining whether a set of output values associated with the first stable state equal a set of output values associated with the second stable state and determining whether a set of state transitions achievable from the first stable state equal a set of state transitions achievable from the second stable state.

Selectively reducing the number of states associated with the computer circuit may also include, for example, identifying stable states that are inaccessible by a state transition. Inaccessible states may then be eliminated. In one example, identifying stable states that are inaccessible by a state transition may include determining whether a second state can be reached from a first known state given a first set of input values and state node values associated with the first known state. Whether the transition can occur may depend on whether there is a second set of input values and state node values that can drive the computer circuit into the second state. It is to be appreciated that in some examples the second set of input values may include a series or sequence of second input values that may be applied over a period of time rather than a single input value.

Selectively eliminating an inaccessible stable state may include, for example, selectively updating a state table and/or selectively updating a state transition table. Updating the table(s) may include, for example, removing a row from the table(s). An inaccessible state may refer, for example, to a state/input combination. Thus, removing a state may refer to manipulating (e.g., eliminating) a data entry associated with a state.

Table 3 illustrates a reduced state table for circuit 100. While Table 1 included eight rows, method 200 facilitates reducing Table 1 down to Table 3, which include six rows.

TABLE 3
Reduced State Table For Circuit 100.

| Input CK | Input IN | State node S | Output Q | Output NCK |
|---|---|---|---|---|
| 0 | 0 | 0 (State = A) | 1 | 1 |
| 0 | 0 | 1 (State = B) | 0 | 1 |
| 0 | 1 | 0 (State = A) | 1 | 1 |
| 0 | 1 | 1 (State = B) | 0 | 1 |
| 1 | 0 | 0 (State-A) | 1 | 0 |
| 1 | 1 | 1 (State = B) | 0 | 0 |

Table 4 illustrates a reduced state transition table for circuit 100. While Table 2 included eight rows, method 200 facilitates reducing Table 2 down to Table 4, which includes six rows.

TABLE 4
Reduced State Transition Table For Circuit 100.

| | Current | Next State if CK | Next State if IN |
|---|---|---|---|
| | inputs (CK, | Changes to its | Changes to its |
| Current State | IN) | Opposite Value | Opposite Value |
| A (S = 0) | 0, 0 | A | A |
| A (S = 0) | 0, 1 | B | A |
| A (S = 0) | 1, 0 | A | B |
| B (S = 1) | 0, 0 | A | B |
| B (S = 1) | 0, 1 | B | B |
| B (S = 1) | 1, 1 | B | A |

Method 200 may also include, at 240, generating a set of test vectors associated with the computer circuit based, at least in part, on the predicted logical behavior for the computer circuit. Test vectors may be generated differently based, for example, on whether a circuit is a combinational circuit or a sequential circuit. Generating a set of test vectors associated with a combinational circuit may include, for example, simply associating an input value with an output value for different entries in the state table. Generating a set of test vectors associated with a sequential circuit may be more complicated. For example, it may include creating a first test vector by associating a first input value with an output value and then creating subsequent test vectors related to the first test vector by associating an input value with an output value. In one example, a subsequent test vector may differ from a previous test vector by one and only one input value.

Table 5 illustrates one example test sequence for analyzing circuit 100. Circuit 100 is an example of a sequential circuit where the outputs depend on the inputs and on a state node(s) value(s).

TABLE 5
Test Sequence For Circuit 100.

| Test vector # | Input values (CK, IN) | Expected output values (Q, NCK) |
|---|---|---|
| 1 | 0, 0 | X, 1 |
| 2 | 1, 0 | 1, 0 |
| 3 | 1, 1 | 0, 0 |
| 4 | 1, 0 | 1, 0 |
| 5 | 0, 0 | 1, 1 |
| 6 | 1, 0 | 1, 0 |
| 7 | 1, 1 | 0, 0 |
| 8 | 0, 1 | 0, 1 |
| 9 | 1, 1 | 0, 0 |
| 10 | 0, 1 | 0, 1 |
| 11 | 0, 0 | 0, 1 |
| 12 | 1, 0 | 1, 0 |
| 13 | 0, 0 | 1, 1 |
| 14 | 0, 1 | 1, 1 |
| 15 | 1, 1 | 0, 0 |

Table 6 illustrates an example test sequence for a 3-input NAND gate. A 3-input NAND gate is an example of a combinational circuit where the outputs depend on the inputs and not on a state node(s) value(s).

TABLE 6
Test Sequence For 3-input NAND Gate.

| Test vector # | Input values (A, B, C) | Expected output values (Z) |
|---|---|---|
| 1 | 0, 0, 0 | 1 |
| 2 | 0, 0, 1 | 1 |
| 3 | 0, 1, 0 | 1 |
| 4 | 0, 1, 1 | 1 |
| 5 | 1, 0, 0 | 1 |
| 6 | 1, 0, 1 | 1 |
| 7 | 1, 1, 0 | 1 |
| 8 | 1, 1, 1 | 0 |

The test vectors may be used in various applications. For example, method 200 may be extended (not illustrated) to include programmatically redesigning a CMOS circuit design from a first circuit family to a second circuit family based, at least in part, on the predicted logical behavior for the computer circuit as validated by a circuit analysis tool that accepts the set of test vectors as an input. The first circuit family may be, for example, static CMOS logic and the second circuit family may be, for example, pseudo-NMOS logic.

In one example, methodologies may be implemented as processor executable instructions and/or operations stored on a computer-readable medium. Thus, in one example, a computer-readable medium may store processor executable instructions operable to perform a method that includes accessing a netlist that is configured to describe a computer circuit and accessing a switch level circuit simulator that is configured to facilitate determining a predicted logical behavior for the computer circuit based on data stored in the netlist.

The method may also include programmatically determining the predicted logical behavior for the computer circuit by, for example, identifying state nodes associated with the computer circuit, identifying stable states for the identified state nodes, identifying state transitions between the identified stable states and selectively reducing the number of states associated with the computer circuit. Selectively reducing the number of states may include, for example, selectively combining stable states into a single stable state, and identifying and selectively eliminating stable states that are inaccessible by a state transition.

The method may also include, for example, generating a set of test vectors associated with the computer circuit. The test vectors may be based, at least in part, on the predicted logical behavior for the computer circuit. While the above method is described being stored on a computer-readable medium, it is to be appreciated that other example methods described herein may also be stored on a computer-readable medium.

A test vector may include a set of input values that can be applied to inputs of a circuit and a set of output values that the circuit is expected to produce in response to the inputs. If the actual outputs produced when a set of input values are applied do not match the expected output values as recorded in a test vector, then the circuit being tested may be, for example, flawed, malfunctioning, and the like. This is one way in which test vectors may facilitate analyzing a computer circuit.

A test vector may include one set of input values and one set of output values. But a circuit may take on more than one set of output values based on more than one set of input values. Therefore test vectors may be organized into a set of test vectors. The set of test vectors may be referred to as a test sequence. In one example, a test sequence is an ordered set of test vectors that facilitate analyzing a computer circuit as it is moved from state to state by applying different input values.

In one example, test vectors can be generated that facilitate examining, for example, substantially every entry in a state table and a state transition table associated with a circuit to be analyzed. This facilitates improving coverage in circuit testing. In another example, test vectors can be generated that facilitate examining selected portions of a state table and a state transition table. This facilitates refining coverage for circuit testing. In one example, test vectors may be generated using different methods depending, for example, on whether the circuit to be analyzed using the test vectors is a combinational circuit or a sequential circuit. A combinational circuit has no state nodes while a sequential circuit has state nodes.

FIG. 3 illustrates an example system 300 associated with determining circuit behavior. System 300 may include a data acquisition logic 310 that is configured to access a netlist 320 that describes a computer circuit 330. The netlist 320 may be stored, for example, in a data store (e.g., file, database, table).

System 300 also includes a logical behavior logic 340 that is configured to facilitate determining a predicted logical behavior for the computer circuit 330. The logical behavior logic 340 predicts the logical behavior based, at least in part, on netlist 320. In one example, the logical behavior logic 340 may be configured to produce a state table 370 that describes a set of states the computer circuit 330 can experience. While a “table” is described, it is to be appreciated that the set of states the computer circuit 330 may experience may be stored in other data structures like a file, a list, a tree, and the like. Additionally, while a “table” is described, it is to be appreciated that in some examples the logical behavior logic 340 may analyze inputs, outputs, state values, and so on “on the fly” as switch level circuit simulation actions are performed by the logical behavior logic 340. Thus, no static, complete table may be output. The logical behavior logic 340 may also be configured to produce a state transition table 380 that describes a set of transitions between states described in the state table 370. Once again, while a “table” is described, it is to be appreciated that data concerning state transitions may be stored in other data structures.

System 300 also includes a test vector logic 350 that is configured to generate a set of test vectors 360. The test vectors 360 may facilitate analyzing the computer circuit 330. For example, the test vectors 360 may be used as inputs to a circuit analysis tool (not illustrated). The test vectors 360 generated may depend, for example, on the predicted logical behavior for the computer circuit 330.

Generating the test vectors 360 may involve accessing data concerning states in the state table 370 and data concerning state transitions in the state transition table 380. Thus, generating the test vectors 360 may be made less computationally intensive by simplifying the state table 370 and/or the state transition table 380. Therefore, in one example, the logical behavior logic 340 may be configured to determine whether a state in the state table 370 is a stable state. States may be selectively removed from the state table 370 based on their stability. A stable state may be considered to be a combination of input values and state node values that the circuit 330 can maintain, even if state nodes are free to change value.

While instability is one reason for removing a state from the state table 370, inaccessibility may be another. Thus, in one example, the switch level circuit simulation logic 340 may be configured to selectively remove a state from the state table 370 if the state can not be reached from another selected state in the state table 370. This selective removal addresses the issue of having an entry in the state table 370 representing a first state that can not be visited from the starting point of a selected second state in the state table 370 and the possibility that the circuit 330 may power up with input values and state node values corresponding to the second state. In this situation, no set of input transitions could cause the circuit 330 to take on the first state. Thus, the first state can be “removed” from the state table 370. Removing a state from the state table 370 and/or removing a state transition from the state transition table 380 may involve a logical and/or physical process. For example, removing a state may include setting a value in a field in a state record that indicates that the state is to be ignored, and thus logically removed. Similarly, removing a state transition may include setting a bit in a bitfield associated with a state transition data structure, where the bitfield controls whether the physical entry is logically present.

With the state table 370 and the state transition table 380 simplified, the test vector logic 350 may then produce a set of test vectors 360 that facilitate validating a simulation of the computer circuit 330. The test vectors 360 that are generated may depend, at least in part, on data stored in the state table 370 and/or the state transition table 380. As described above, the test vectors 360 may include input values associated with expected output values. The test vectors 360 may then be supplied, for example, to a circuit analysis tool configured to analyze the circuit 330. In one example, test vectors 360 may be generated that visit substantially every entry in the state table 370 and the state transition table 380. In another example, test vectors 360 may be generated that visit a selected set of entries in the state table 370 and the state transition table 380. Thus, in different examples, test vectors 360 that support circuit analysis with both wide coverage and/or narrow focus may be generated.

The test vector logic 350 may be configured to generate test vectors 360 for a combinational circuit and/or a sequential circuit. For a combinational circuit, the order of the test vectors 360 may be unimportant, while for a sequential circuit, the order of the test vectors 360 may be important, and thus the test vectors 360 may be organized into a test sequence as described above.

FIG. 4 illustrates an example method 400 for producing a test sequence of test vectors configured to facilitate analyzing a computer circuit. The method 400 includes programmatically creating 410 a state table. The state table will be produced from a netlist that is configured to describe the computer circuit. The state table will store information about inputs, state node values (if any), and outputs for the circuit. Programmatically creating a state table may involve one or more actions. The actions may include, for example, identifying a node as a state node if the node is explicitly identified as a state node in the netlist. Additionally and/or alternatively, a node may be identified as a state node if it is connected to the gate of at least one transistor, has a transistor channel connection other than the source and drain connections of a single inverter output, and is on a path that goes through a transistor gate connected to the node being tested and returns to the node being tested using only gate to source, gate to drain, drain to source, and source to drain paths. After identifying a node as a state node, programmatically creating 410 the state table may include manipulating (e.g., creating, updating, adding, changing a value in) an entry associated with the identified state node to the state table.

Method 400 also includes, programmatically creating 420 a state transition table. The state transition table will store information about inputs, state node values (if any), outputs, and transitions between the states stored in the state table. Between them, the state table and the state transition table characterize the logical behavior of the computer circuit.

However, the state table and the state transition table may include redundant states, inaccessible states, meaningless state transitions, and so on. Thus, method 400 may also include, at 430, selectively simplifying the state table. Simplifying 430 the state table may include, for example, selectively reducing the number of states described in the state table. In one example, selectively reducing the number of states described in the state table includes combining two or more compatible states into a single state.

Similarly, method 400 may include selectively simplifying 440 the state transition table. Simplifying 440 the state transition table may include, for example, selectively reducing the number of state transitions described in the state transition table. Reducing the number of state transitions described in the state transition table may include, for example, eliminating inaccessible states and state transitions associated therewith.

Method 400 may also include, at 450, producing test vectors that are based on the simplified state table and the simplified state transition table. In one example, the test vectors may be organized into a test sequence of test vectors.

Programmatically creating 420 a state transition table may include, for example, performing a set of actions for sets of state nodes found in the state table. In one example, a set of state nodes may include all the state nodes in the state table while in another example a set of state nodes may include a subset of all the state nodes in the state table. For the set of state nodes, actions may be performed for sets of inputs to the circuit. In one example, the sets of inputs include all inputs to the circuit while in another example the sets of inputs may include a subset of all the inputs to the circuit. For the sets of inputs, the following actions may be taken to add an entry to the state transition table. For example, a value may be established for an input and for a state node and then the operation of the computer circuit may be simulated. After simulating the operation of the circuit, the value of a state node may be recorded. Then, the value for an input may be changed to determine whether that causes a state transition. Thus, after changing the value for the input, the operation of the computer circuit may be resimulated and the value of the state node reexamined and compared to the recorded value. If the value has changed, then a state transition has been identified and an entry can be manipulated (e.g., created, edited) in the state transition table.

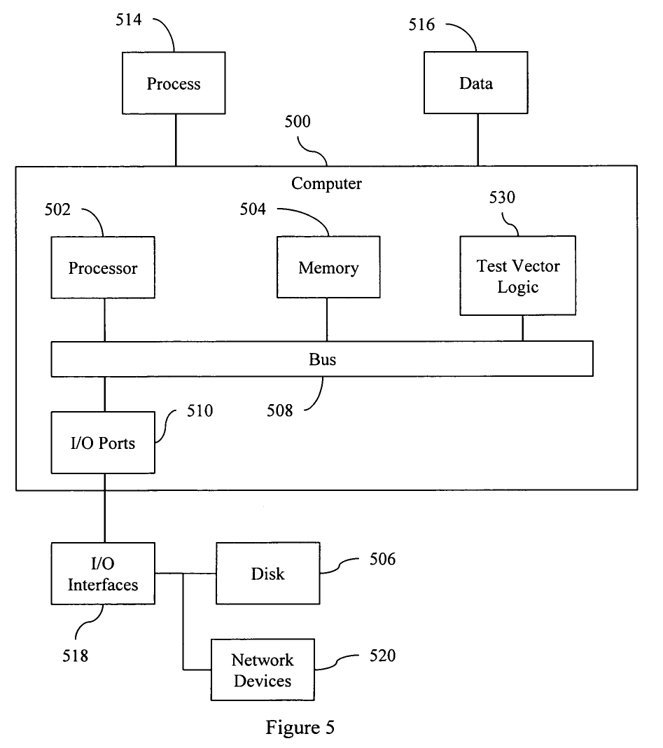

FIG. 5 illustrates a computer 500 that includes a processor 502, a memory 504, and input/output ports 510 operably connected by a bus 508. In one example, the computer 500 may include a test vector logic 530 that is configured to produce test vectors based on an automatic determination of a circuit behavior. Thus, the test vector logic 530, whether implemented in computer 500 as hardware, firmware, software, and/or a combination thereof may provide means for acquiring a switch level description of a computer circuit, means for predicting the logical operation of the computer circuit from the switch level description of the computer circuit, and means for generating a set of test vectors configured to facilitate analyzing a physical or logical implementation of the computer circuit based, at least in part, on the predicted logical operation of the computer circuit.

The processor 502 can be a variety of various processors including dual microprocessor and other multi-processor architectures. The memory 504 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 506 may be operably connected to the computer 500 via, for example, an input/output interface (e.g., card, device) 518 and an input/output port 510. The disk 506 can include, but is not limited to, devices like a magnetic disk drive, a solid state disk drive, a floppy disk drive, a tape drive, a Zip drive, a flash memory card, and/or a memory stick. Furthermore, the disk 506 can include optical drives like a CD-ROM, a CD recordable drive (CD-R drive), a CD rewriteable drive (CD-RW drive), and/or a digital video ROM drive (DVD ROM). The memory 504 can store processes 514 and/or data 516, for example. The disk 506 and/or memory 504 can store an operating system that controls and allocates resources of the computer 500.

The bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet). The bus 508 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 500 may interact with input/output devices via i/o interfaces 518 and input/output ports 510. Input/output devices can include, but are not limited to, a keyboard, a microphone, a pointing and selection device, cameras, video cards, displays, disk 506, network devices 520, and the like. The input/output ports 510 can include but are not limited to, serial ports, parallel ports, and USB ports.

The computer 500 can operate in a network environment and thus may be connected to network devices 520 via the i/o interfaces 518, and/or the i/o ports 510. Through the network devices 520, the computer 500 may interact with a network. Through the network, the computer 500 may be logically connected to remote computers. The networks with which the computer 500 may interact include, but are not limited to, a local area network (LAN), a wide area network (WAN), and other networks. The network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 520 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, and/or through a network may include combinations and mixtures of communications.

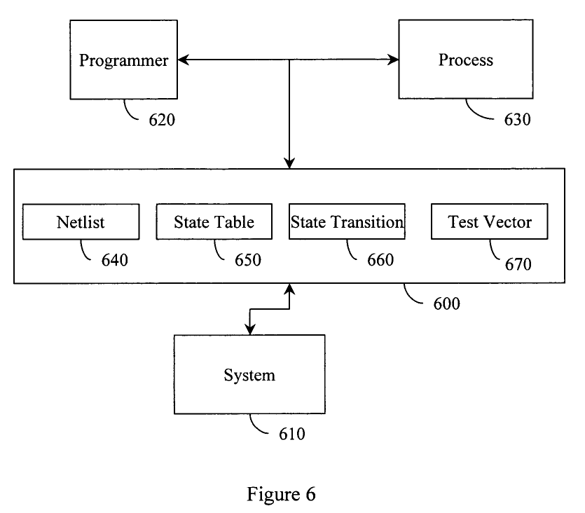

Referring now to FIG. 6, an application programming interface (API) 600 is illustrated providing access to a system 610 for generating test vectors based on a programmatic determination of circuit behavior. The API 600 can be employed, for example, by a programmer 620 and/or a process 630 to gain access to processing performed by the system 610. For example, a programmer 620 can write a program to access the system 610 (e.g., invoke its operation, monitor its operation, control its operation) where writing the program is facilitated by the presence of the API 600. Rather than programmer 620 having to understand the internals of the system 610, the programmer 620 merely has to learn the interface to the system 610. This facilitates encapsulating the functionality of the system 610 while exposing that functionality. Similarly, the API 600 can be employed to provide data values to the system 610 and/or retrieve data values from the system 610. For example, a process 630 that processes a netlist to produce a state table can provide the state table and/or data associated therewith to the system 610 via the API 600 by, for example, using a call provided in the API 600.

In one example of the API 600, a set of application programming interfaces can be stored on a computer-readable medium. The interfaces can be employed by a programmer, computer component, logic, and so on, to gain access to a system 610 for generating test vectors based on a programmatic determination of circuit behavior. The interfaces can include, but are not limited to, a first interface 640 that communicates a netlist data and a second interface 650 that communicates a state table data. The state table data may be derived, at least in part, from the netlist data. The interfaces may also include a third interface 660 that communicates a state transition table data that is derived, at least in part, from the netlist data and the state table data. The interfaces may also include a fourth interface 670 for communicating a test vector data. The test vector data may be derived, at least in part, from the state table data and the state transition table data.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A method, comprising:
accessing a netlist configured to describe a computer circuit;
accessing a switch level circuit simulator configured to facilitate determining a predicted logical behavior for the computer circuit based, at least in part on the netlist;
programmatically determining the predicted logical behavior for the computer circuit; and
generating a set of test vectors associated with the computer circuit based, at least in part, on the predicted logical behavior for the computer circuit.

2. The method of claim 1, where programmatically determining the predicted logical behavior for the computer circuit includes:
identifying one or more state nodes associated with the computer circuit;
identifying one or more stable states for the one or more state nodes;
identifying one or more state transitions between the one or more stable states; and
selectively reducing a number of states associated with the computer circuit.

3. The method of claim 2, where selectively reducing the number of states associated with the computer circuit includes:
selectively combining two or more stable states into a single stable state;
identifying one or more stable states that are inaccessible by a state transition; and
selectively eliminating one or more stable states that are inaccessible.

4. The method of claim 2, where identifying the one or more state nodes includes identifying whether a path that goes through a transistor gate connected to a node being considered as a state node returns to the node being considered as a state node, where the path passes through one or more transistors using only gate to source, gate to drain, drain to source, and source to drain paths.

5. The method of claim 2, where identifying the one or more state nodes includes examining a node that is connected to a gate and tracing a path from the gate.

6. The method of claim 2, where identifying the one or more state nodes includes:
determining whether a node is connected to a gate of at least one transistor in the computer circuit;
determining whether the node has a transistor channel connection other than the source and drain connections of a single inverter in the computer circuit; and
determining whether the node is on a path that goes through a transistor gate connected to the node and returns to the node after passing through one or more transistors using only gate to source, gate to drain, drain to source, and source to drain paths.

7. The method of claim 6, including determining whether the path includes one or more of, a source to gate path, and a drain to gate path.

8. The method of claim 6, including determining whether the path includes one or more of, a gate to source path, a gate to drain path, a drain to source path, and a source to drain path.

9. The method of claim 2, where identifying the one or more state nodes includes determining whether a node is identified as a state node in the netlist.

10. The method of claim 2, including updating a state table to record the identification of a state node.

11. The method of claim 10, including updating the state table to record the identification of a stable state for a state node.

12. The method of claim 2, where identifying one or more stable states for the one or more state nodes includes:
controlling the switch level circuit simulator to establish an initial known input value for one or more inputs associated with the computer circuit;
controlling the switch level circuit simulator to establish an initial known node value for one or more state nodes associated with the computer circuit;
controlling the switch level circuit simulator to simulate operation of the circuit; and
determining whether a state node acquired a node value different from the initial known node value for the state node after simulating operation of the circuit.

13. The method of claim 12, where establishing the initial known input value for one or more inputs associated with the computer circuit includes selectively establishing all possible combinations of logical ones and logical zeroes for the one or more inputs.

14. The method of claim 13, where establishing the initial known node value for one or more state nodes associated with the computer circuit includes selectively establishing all possible combinations of logical ones, logical zeroes, and logical undefined values for the one or more state nodes associated with the computer circuit.

15. The method of claim 12, where establishing the initial known input value for one or more inputs associated with the computer circuit includes selectively establishing a set of combinations of logical ones and logical zeroes for one or more inputs associated with the computer circuit.

16. The method of claim 15, where establishing the initial known node value for one or more state nodes associated with the computer circuit includes selectively establishing a set of combinations of logical ones, logical zeroes, and logical undefined values for one or more state nodes associated with the computer circuit.

17. The method of claim 2, where identifying one or more state transitions between the one or more stable states includes:
controlling the switch level circuit simulator to establish an initial known node value for a state node associated with the computer circuit, where the initial known node value is retrieved from a state table;
controlling the switch level circuit simulator to establish an initial known input value for a set of inputs associated with the computer circuit, where the initial known input value is retrieved from the state table;
controlling the switch level circuit simulator to simulate operation of the circuit;
controlling the switch level circuit simulator to record a first node value for the state node;
controlling the switch level circuit simulator to establish a second known input value for the set of inputs associated with the computer circuit;
controlling the switch level circuit simulator to resimulate the operation of the circuit; and
determining whether the state node achieved a value different from the first node value after resimulating operation of the circuit.

18. The method of claim 17, including selectively updating a state transition table to record a state transition based, at least in part, on determining whether the state node achieved a value different from the first node value after resimulating operation of the circuit.

19. The method of claim 3, where selectively combining two or more stable states into a single stable state includes:
comparing a first stable state to a second stable state to determine whether the first stable state and the second stable state are compatible.

20. The method of claim 19, where comparing the first stable state to the second stable state includes determining whether an input value combination associated with the first stable state is also associated with the second stable state.

21. The method of claim 19, where comparing the first stable state to the second stable state includes determining whether an input value combination associated with the first stable state is also associated with the second stable state and if so, determining whether a set of output values associated with the first stable state equal a set of output values associated with the second stable state, and determining whether a set of state transitions achievable from the first stable state equal a set of state transitions achievable from the second stable state.

22. The method of claim 3, where identifying one or more stable states that are inaccessible by a state transition includes determining whether, given a first set of input values and state node values associated with a first known state there exists one or more second sets or series of input values and state node values that after simulating circuit operation will place the computer circuit in a second known state.

23. The method of claim 3, where selectively eliminating one or more of the stable states that are inaccessible includes:
selectively updating a state table based, at least in part, on identifying a stable state that is inaccessible; and
selectively updating a state transition table based, at least in part, on identifying a stable state that is inaccessible.

24. The method of claim 1, where generating a set of test vectors associated with a combinational computer circuit based, at least in part, on the predicted logical behavior for the computer circuit includes, for members of a set of entries in the state table, associating an input value with an output value.

25. The method of claim 1, where generating a set of test vectors associated with a sequential computer circuit based, at least in part, on the predicted logical behavior for the computer circuit includes, for members of a set of entries in a state table:
creating a first test vector by associating a first input value with an output value; and
creating one or more subsequent test vectors related to the first test vector by associating an input value with an output value, where a subsequent test vector differs from a previous test vector by one input value.

26. The method of claim 1, including programmatically redesigning a CMOS circuit design from a first circuit family to a second circuit family based, at least in part, on the predicted logical behavior for the computer circuit as validated by a circuit analysis tool that accepts the set of test vectors as an input.

27. A computer-readable medium storing computer executable instructions operable to perform a method, the method comprising:
accessing a netlist configured to describe a computer circuit;
accessing a switch level circuit simulator configured to facilitate determining a predicted logical behavior for the computer circuit based, at least in part on the netlist;
programmatically determining the predicted logical behavior for the computer circuit by:
identifying one or more state nodes associated with the computer circuit;
identifying one or more stable states for the one or more state nodes;
identifying one or more state transitions between the one or more stable states; and
selectively reducing the number of states associated with the computer circuit by:
selectively combining two or more stable states into a single stable state;
identifying one or more stable states that are inaccessible by a state transition; and
selectively eliminating one or more of the stable states that are inaccessible; and
generating a set of test vectors associated with the computer circuit based, at least in part, on the predicted logical behavior for the computer circuit.

28. A system comprising:
a data acquisition logic configured to access a netlist that describes a computer circuit;
a logical behavior logic configured to facilitate determining a predicted logical behavior for the computer circuit based, at least in part, on the netlist; and
a test vector logic configured to generate a set of test vectors configured to facilitate analyzing the computer circuit, where the test vectors are based, at least in part, on the predicted logical behavior for the computer circuit.

29. The system of claim 28, the logical behavior logic being configured to produce a state table that describes a set of states the computer circuit can experience.

30. The system of claim 29, the logical behavior logic being configured to produce a state transition table that describes a set of transitions between states described in the state table that the computer circuit can experience.

31. The system of claim 30, the logical behavior logic being configured to determine whether a state in the state table is a stable state and to selectively remove a state from the state table if it is not a stable state.

32. The system of claim 31, the logical behavior logic being configured to selectively remove a second state from the state table if the second state can not be reached from a selected first state in the state table.

33. The system of claim 32, the test vector logic being configured to produce a set of test vectors that facilitate validating a simulation of the computer circuit, the test vectors being generated based, at least in part, on the state table and the state transition table.

34. A method for producing a test sequence of test vectors configured to facilitate analyzing a computer circuit, comprising:
programmatically creating, from a netlist configured to describe the computer circuit, a state table and a state transition table that store data that characterizes the behavior of the computer circuit;
selectively simplifying the state table by selectively reducing a number of states described in the state table;
selectively simplifying the state transition table by selectively reducing a number of state transitions described in the state transition table; and
producing the test sequence of test vectors based, at least in part, on the simplified state table and the simplified state transition table.

35. The method of claim 34, where selectively reducing the number of states described in the state table includes combining two or more compatible states into a single state.

36. The method of claim 35, where selectively reducing the number of state transitions described in the state transition table includes eliminating one or more inaccessible states.

37. The method of claim 36, where programmatically creating a state table includes:
identifying a node as a state node if the node is either explicitly identified as a state node in the netlist or the node is connected to the gate of at least one transistor, has a transistor channel connection other than the source and drain connections of a single inverter output, and is part of a path that goes though a transistor gate connected to the node and returns to the node, where the path passes through one or more transistors using only gate to source, gate to drain, drain to source, and source to drain paths; and
manipulating an entry associated with the identified state node to the state table.

38. The method of claim 37, where programmatically creating a state transition table includes:
for state nodes represented in the state table
for inputs to the circuit
establishing a value for an input;
establishing a value for a state node;
simulating operation of the computer circuit;
after simulating the operation of the circuit:
recording a state node value;
changing the value for the input;
resimulating operation of the computer circuit; and comparing the state node value to a value taken by the state node after changing the value for the input and resimulating operation of the computer circuit

39. A set of application programming interfaces embodied on a computer-readable medium for execution by a computer component in conjunction with generating test vectors based on a programmatic determination of circuit behavior, comprising:
a first interface for communicating a netlist data;
a second interface for communicating a state table data, where the state table data is derived, at least in part, from the netlist data;
a third interface for communicating a state transition table data, where the state transition table data is derived, at least in part, from the netlist data and the state table data; and
a fourth interface for communicating a test vector data, where the test vector data is derived, at least in part, from the state table data and the state transition table data.

40. A system, comprising:
means for acquiring a switch level description of a computer circuit;
means for predicting the logical operation of the computer circuit from the switch level description of the computer circuit; and
means for generating a set of test vectors configured to facilitate analyzing a physical or logical implementation of the computer circuit based, at least in part, on the predicted logical operation of the computer circuit.
